(19) United States
(12) Patent Application Publication
(10) Pub. No.: US 2009/0284696 A1
(43) Pub. Date: Nov. 19, 2009

(54) PHOTONIC CRYSTAL TYPE COLOR FILTER AND REFLECTIVE LIQUID CRYSTAL DISPLAY DEVICE HAVING THE SAME

(75) Inventors: Byoung-ho CHEONG, Yongin-si (KR); Oleg PRUDNIKOV, Yongin-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/393,054

(22) Filed: Feb. 26, 2009

(30) Foreign Application Priority Data
May 13, 2008 (KR) 10-2008-0044020

(51) Int. Cl. G02F 1/1335; G02B 5/28

(52) U.S. Cl. 349/106; 359/577; 977/902

(57) ABSTRACT

Provided are a photonic crystal type color filter and a reflective liquid crystal display (“LCD”) device having the same. The photonic crystal type color filter includes a substrate, and a photonic crystal disposed on the substrate and having a two-dimensional (2D) grating structure.

This application claims priority to Korean Patent Application No. 10-2008-0044020, filed on May 13, 2008, and all the benefits accruing therefrom under 35 U.S.C.§119, the disclosure of which is incorporated herein in its entirety by reference.

### BACKGROUND OF THE INVENTION

1. Field of the Invention

The present invention relates to a color filter, and more particularly, to a photonic crystal type color filter realizing high color purity and high luminous efficiency, and a reflective liquid crystal display (“LCD”) device having the same.

2. Description of the Related Art

Pigment dispersion methods whereby, a solution in which a pigment is dispersed into a photoresist is applied on a substrate and the photoresist is patterned and color pixels are formed, are used in conventional methods for manufacturing a color filter. Such pigment dispersion methods may use a photolithography process. Thus, the color filter can be implemented in a large area with thermal and chemical stability and color uniformity. However, in such a pigment type color filter, color characteristics are determined by an absorption spectrum of a dispersed pigment, and as the thickness of the color filter increases, light transmittance decreases. Also, when color filters with relatively high color purity are manufactured, brightness deteriorates.

In order to address these disadvantages, photonic crystal type color filters based on a structural color have been studied. Such photonic crystal type color filters control the reflection or absorption of light incident from the outside (e.g., external to the LCD device) by using a nano structure having a relative smaller size than the wavelength of light, thereby reflecting (or transmitting) light having a desired color and transmitting (or reflecting) light having other colors.

Photonic crystal type color filters may include a structure in which unit blocks, each having a nano size, are periodically arranged on a substrate, to be separated from one another at substantially regular intervals. The optical characteristics of photonic crystal type color filters are determined by their structure such that a structure suitable for a specific wavelength is manufactured, wavelength selectivity is excellent and a color band is relatively easily adjusted. Owing to such advantageous characteristics, photonic crystal type color filters can be applied to a reflective liquid crystal display (“LCD”) device using external light having a relatively wide spectrum distribution.

Conventional photonic crystal type color filters having a one-dimensional grating structure have been used. In such conventional photonic crystal type color filters having the one-dimensional grating structure, unit blocks each having a nano size and a photonic crystal are linearly formed, and the linear unit blocks are one-dimensionally arranged on a transparent substrate. When white light is incident on such conventional photonic crystal type color filters, light diffracted by a periodic nano grating and having a specific wavelength is guided onto the substrate, and light having other wavelengths is transmitted to or is reflected from the substrate. Here, a phenomenon in which a distance between gratings is adjusted such that only light having a specific wavelength is transmitted to (or is reflected from) the substrate and light having other wavelengths is guided onto the substrate, is called guided mode resonance (“GMR”).

### BRIEF SUMMARY OF THE INVENTION

Since a liquid crystal device (LCD) may include a photonic crystal type color filters having a one-dimensional grating structure, there may be technical challenges in manufacturing and using such a structure. For example, in photonic crystal type color filters having a one-dimensional grating structure, a spectrum band is relatively wide and wavelength selectivity is not optimum, and light transmittance is relatively low, such as approximately 60%. Due to polarization selectivity according to the characteristics of the one-dimensional grating structure, only light having a specific polarization is transmitted onto the substrate (for example, p-polarized light is transmitted onto the substrate, and s-polarized light is not transmitted onto the substrate and vice versa) such that luminous efficiency is significantly lowered.

In addition, a color change problem in which the color of reflected (or transmitted) light is changed when the incident angle of light incident to a color filter is changed or a viewing angle of a person who views light is changed, occurs. For example, when a color filter is manufactured to be viewed as red is viewed from the front side of the color filter, the color filter seems to be red and when the color filter is viewed at a different angle, the color filter may be viewed as green or blue.

An exemplary embodiment of the present invention provides a photonic crystal type color filter realizing high color purity and high luminous efficiency, and a reflective liquid crystal display (“LCD”) device having the same.

In an exemplary embodiment of the present invention, there is provided a photonic crystal type color filter, including a substrate and a photonic crystal disposed on the substrate to having a two-dimensional (2D) grating structure.

The photonic crystal may be disposed in such a way that unit blocks, forming the grating structure and each having a nano size, may be two-dimensionally arranged to be separated from one another at regular intervals.

The wavelength of light selectively reflected from or transmitted to the color filter may be determined by the sizes of the unit blocks, a distance between the unit blocks, a material of the unit blocks, and a material of the substrate. The unit blocks may be arranged in a substantially square formation, a hexagonal formation or a combination of square and hexagonal formations. The photonic crystal may be disposed in a single layer or a multi-layer structure. The distance between the unit blocks may be approximately 50 nanometers (nm) to approximately 500 nanometers (nm).

The unit blocks may include a crystal, a compound or an organic material having a refractive index greater than 1.5. The unit blocks may include of Si, SiC, ZnS, AlN, BN, GaTe, AgI, TiO₂, SiON, GaP or a compound thereof.

In another exemplary embodiment of the present invention, there is provided a reflective liquid crystal display (“LCD”) device, including a substrate, a photonic crystal color filter disposed to have a two-dimensional (2D) grating structure on the substrate, a liquid crystal layer disposed on the photonic crystal color filter, and a polarization film disposed on the liquid crystal layer.

The reflective LCD device may further include a protection layer disposed on the substrate to cover the photonic crystal. The protection layer may include a transparent, organic material.

The reflective LCD device may further include a black matrix absorbing light may be disposed on the bottom surface of the substrate. The reflective LCD device may further a front light unit disposed on the polarization film.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic perspective view of an exemplary embodiment of a portion of a photonic crystal type color filter, according to the present invention;

FIG. 2 is a cross-sectional view of the photonic crystal type color filter of FIG. 1;

FIG. 3 is a schematic plan view of another exemplary of the photonic crystal type color filter of FIG. 1;

FIG. 4 illustrates an exemplary embodiment of a photonic crystal type color filter used for an optical characteristic experiment, according to the present invention;

FIGS. 5A through 5C are graphs respectively illustrating exemplary embodiments of spectrums of red light, green light, and blue light reflected from the photonic crystal type color filter of FIG. 4 according to the altitude θ of the reflected light;

FIGS. 6A through 6C are graphs illustrating a spectrum of green light reflected from the photonic crystal type color filter of FIG. 4 according to the azimuth φ of the reflected light; and

FIG. 7 is a schematic cross-sectional view of an exemplary embodiment of a reflective liquid crystal display (“LCD”) device, according to the present invention.

### DETAILED DESCRIPTION OF THE INVENTION

The present invention will now be described more fully with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. Like reference numerals in the drawings denote like elements, and the sizes or the thicknesses of elements are exaggerated for clarity.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be described in detail with reference to the accompanying drawings.

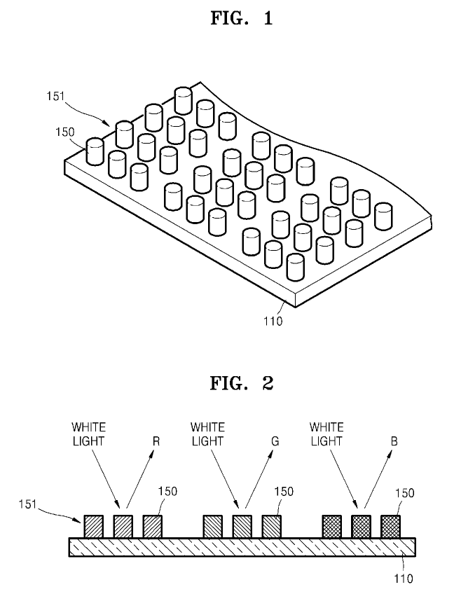

FIG. 1 is a schematic perspective view of an exemplary embodiment of a portion of a photonic crystal type color filter according to the present invention, and FIG. 2 is a cross-sectional view of the photonic crystal type color filter of FIG. 1.

Referring to FIGS. 1 and 2, the photonic crystal type color filter, according to an illustrated exemplary embodiment of the present invention, includes a substrate 110 and a photonic crystal member 151 disposed on the substrate 110. The substrate 110 may be a substantially transparent substrate, for example, a glass substrate. However, the present invention is not limited thereto, and a bendable, transparent plastic substrate may alternatively be used.

Each photonic crystal member 151 may include a plurality of a unit block 150 having a nano size. The plurality of a unit block 150 may collectively be referred to as a single, individual photonic crystal member 151. A plurality of the photonic crystal member 151 may be disposed as a two-dimensional grating (e.g., matrix type) structure on the substrate 110. Referring to FIG. 1, a first photonic crystal member 151 is disposed at an upper-leftmost position on the substrate 110, a second photonic crystal member 151 is disposed directly adjacent to the first photonic crystal member 151 and on the substrate 110, and a third photonic crystal member 151 is disposed at a lower-rightmost position on the substrate 110. While three photonic crystals member 151 are arranged along a first direction of the substrate 110, the invention is not limited thereto.

A single photonic crystal member 151 may include a plurality of the unit blocks 150, each having a nano size, periodically and two-dimensionally disposed on the substrate 110 to be separated from one another at substantially regular (e.g., constant) intervals. A distance between adjacent ones of the unit blocks 150 forming the photonic crystal member 151, may be about half of the wavelength of visible light, i.e., approximately 50 to 500 nanometers (nm). However, the present invention is not limited thereto, and the unit blocks 150 may be arranged separated from one another at various (e.g., not constant) intervals. A first spacing between adjacent photonic crystals member 151 may be larger than a second spacing between adjacent unit blocks 150, or the first and second spacings may be substantially the same.

In the illustrated embodiment, each of the photonic crystal members 151 includes four rows and three columns of the unit blocks 150, but the invention is not limited thereto. The unit blocks 150 may be aligned substantially linearly in rows and columns. Alternatively, the unit blocks 150 in a first row (or column), may be staggered or offset from the unit blocks 150 in a second row (or column) adjacent to the first row (or column). Outer unit blocks 150 of the photonic crystal member 151 may be spaced apart from edges of the substrate 110 at substantially a same distance from the edges, or may be spaced apart at varying distances from the edges of the substrate 110.

A refractive index of the unit blocks 150 included in the photonic crystal member 151 may be greater than the refractive index of the substrate 110 at may be approximately 1.4 to 1.5. Preferably, the refractive index of the unit blocks 150 included in the photonic crystal member 151 is greater than the refractive index of the substrate 110. The unit blocks 150 may include a crystal, a compound and/or an organic material having a refractive index greater than about 2.0. In one exemplary embodiment, each of the unit blocks 150 may include Si, SiC, ZnS, AlN, BN, GaTe, AgI, TiO₂, SiON, GaP or a compound thereof. However, the present invention is not limited thereto.

In the illustrated embodiment of FIGS. 1 and 2, each of the unit blocks 150 collectively defining the photonic crystal member 151, has a substantially cylindrical shape. However, the present invention is not limited thereto, and each of the unit blocks 150 may alternatively have a substantially rectangular parallelepiped shape or other shapes. An entire of the unit blocks 150 of the photonic crystal member 151 may have a same shape, or a shape of the unit blocks 150 within a photonic crystal member 151 may be different.

In the illustrated embodiment, the photonic crystal member 151 is disposed in a single layer structure. However, the present invention is not limited thereto, and the photonic crystal member 151 may include a plurality of layers of the unit blocks 150, thereby defining a multi-layer structure having two or more layers of the unit blocks 150.

The wavelength of light reflected from (or transmitted to) the photonic crystal type color filter is determined by the sizes (e.g., dimension) of each of the unit blocks 150 two-dimensionally arranged on the substrate 110, a distance between adjacent ones of the unit blocks 150, a material of the unit blocks 150, and/or a material of the substrate 110. The sizes of the unit blocks 150, the distance between adjacent ones of the unit blocks 150, the material of the unit blocks 150, and the material of the substrate 110 may be adjusted such that only light having a desired color from white light incident from the outside is selectively reflected from (or transmitted to) the substrate 110, where light having other colors, other than the desired color, is transmitted to (or reflected from) the substrate 110.

The photonic crystal member 151 may include a plurality of a pixel. A pixel may be considered a continuous region where a plurality of the unit block 150 are disposed. Within a pixel, the sizes of the unit blocks 150 disposed on the substrate 110 and the distance therebetween may be adjusted such that a predetermined red pixel, a predetermined green pixel, and a predetermined blue pixel are disposed on the substrate 110. In an exemplary embodiment, sizes of each of the unit blocks 150 within a continuous pixel region, and a distance between adjacent unit blocks 150 within the pixel region may be substantially the same. Sizes of and distances between the unit blocks 150 of one pixel region, may be different from sizes of and distances between the unit blocks 150 of another pixel region.

In the illustrated embodiment of FIG. 2, a first photonic crystal region of the photonic crystal member 151 may include a first plurality of the unit blocks 150 including of silicon (Si) and having a rectangular parallelepiped shape which are periodically arranged on the glass substrate 110. Each of the unit blocks 150 may have a width of approximately 175 nanometers (nm), and may have a height of approximately 120 nanometers (nm). The plurality of unit blocks 150 may be separated from each other by a distance therebetween of about 350 nanometers (nm). The first photonic crystal region may be a red pixel in which only red light (R) from white light incident from an outside of the photonic crystal member 151 is selectively reflected, as shown by the arrows respectively toward and away from the photonic crystal member 151.

In addition, a second photonic crystal region of the photonic crystal member 151 may include a second plurality of the unit blocks 150 including silicon (Si) and having a rectangular parallelepiped shape which are periodically arranged on the glass substrate 110. Each of the unit blocks 150 may have a width of approximately 120 nm each, and may have a height of approximately 120 nm. The plurality of unit blocks 150 may be separated from each other by a distance therebetween of about 240 nm. The second photonic crystal member 151 may be a green pixel in which only green light (G) from white light incident from the outside is selectively reflected, as shown by the arrows respective toward and away from the photonic crystal member 151.

In addition, a third photonic crystal region of the photonic crystal member 151 may include a third plurality of the unit blocks 150 including silicon (Si) and having a rectangular parallelepiped shape which are periodically arranged on the glass substrate 110. Each of the unit blocks 150 may have a width of approximately 105 nm each, and may have a height of 90 nm each by a distance therebetween of about 210 nm. The third photonic crystal member 151 may be a blue pixel in which only blue light (B) from white light incident from the outside is selectively reflected, as shown by the arrows respective toward and away from the photonic crystal member 151.

The width of a unit block 150 may be a maximum dimension between adjacent edges of the unit block 150 or a same point of adjacent unit blocks 150, taken in a plane or layout view. The height of the unit block 150 may be a dimension from a surface of the substrate 110 upon which the unit block 150 is disposed to a distal point of the unit block 150. The distance between unit blocks 150 may be a dimension between boundaries of adjacent unit blocks 150 taken in the plane or layout view, or a distance between same points on adjacent unit blocks 150.

Relative size of the unit blocks 150 and the distance between adjacent ones of the unit blocks 150 are illustratively described in FIG. 1. In addition, the sizes of the unit blocks 150 and the distance between the unit blocks 150 may be changed, thereby forming red, green, and blue pixels. For explanatory conveniences, FIGS. 1 and 2 illustrate pixels separated from one another at regular intervals so that the red pixel, the green pixel, and the blue pixel can be better distinguished, however the present invention may include the pixels separated from each other at irregular intervals.

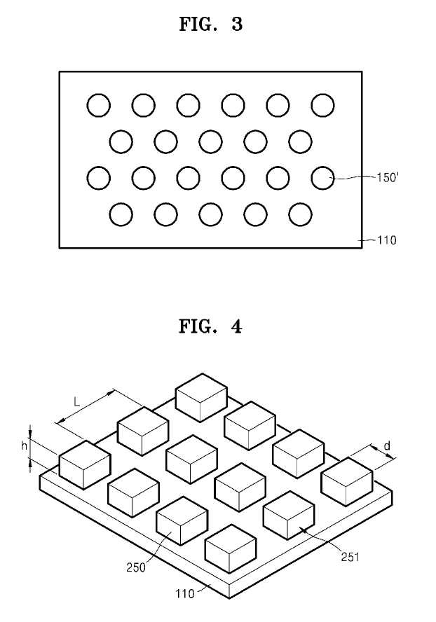

As described above, in the photonic crystal type color filter in the illustrated embodiment of the present invention, the unit blocks 150 each having a nano size, are two-dimensionally arranged on the substrate 110, thereby forming the photonic crystal member 151. Sizes of the unit blocks 150 arranged two-dimensionally, the distance between the unit blocks 150, the material of the unit blocks 150, and/or the material of the substrate 110 are adjusted such that light (specifically, red (R), green (G) or blue (B)) having a predetermined color from white light incident from the outside, is selectively reflected from (or transmitted to) the substrate 110. In FIG. 1, the unit blocks 150 included in the photonic crystal member 151 are arranged substantially in a square formation. However, the present invention is not limited thereto As shown in FIG. 3, unit blocks 150′ may be arranged in a hexagonal formation on the substrate 110, whereby adjacent rows of the unit blocks 150′ are offset from each other. In other exemplary embodiments, the unit blocks 150 and 150′ may be arranged in other formations, such as a combination of square and hexagonal formations.

FIG. 4 illustrates an exemplary embodiment of a photonic crystal type color filter used for an optical characteristic experiment, according to the present invention. In the photonic crystal type color filter illustrated in FIG. 4, each of unit blocks 250 included in the photonic crystal member 251 has substantially a rectangular parallelepiped shape. A plurality of the unit block 250 is arranged in a square formation on the substrate 110. In FIG. 4, a width “d” of each of the unit blocks 250, a height “h” of each of the unit blocks 250, and “L” is a spatial period of the unit blocks 250 are illustrated. In the illustrated embodiment, a substantially planar glass substrate having a refractive index of about 1.5 is used as the substrate 110, and the unit blocks 250 include silicon (Si) having a refractive index of about 4.0. The width “d” may be taken along a longitudinal direction of the substrate 110, and the length “L” may be taken along a transverse direction of the substrate 110 substantially perpendicular to the longitudinal direction.

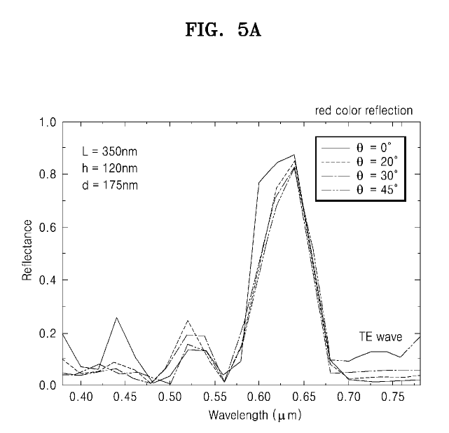

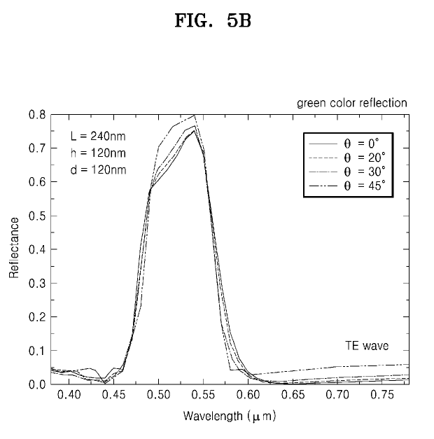

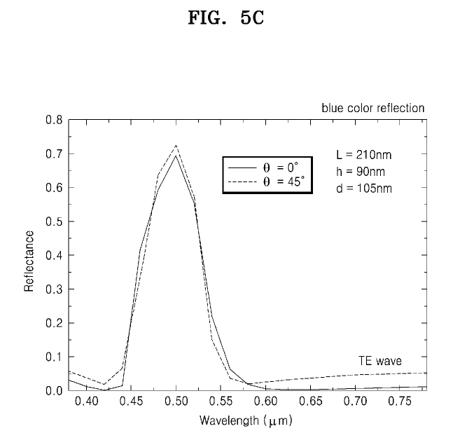

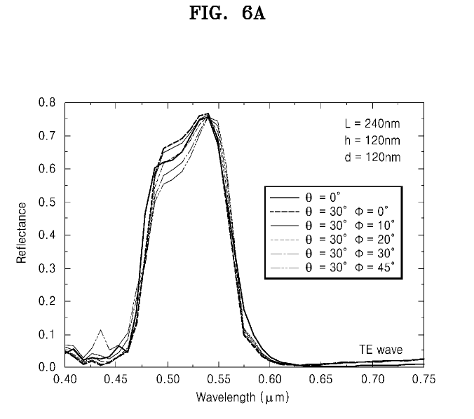

FIGS. 5A through 5C illustrate respective exemplary embodiments of spectrums of red light, green light, and blue light reflected from the photonic crystal type color filter of FIG. 4, according to the altitude θ of the reflected light, using a rigorous coupled wave analysis (“RCWA”). Specifically, FIG. 5A illustrates the result of simulation to obtain a spectrum of red light having a transverse electric (“TE”) wave and reflected from the photonic crystal type color filter of FIG. 4 by changing the altitude θ of the reflected light. The spatial period “L” of the unit blocks 250, the height “h” of each of the unit blocks 250, and the width “d” of each of the unit blocks 250 were 350 nm, 120 nm, and 175 nm, respectively. Referring to FIG. 5A, when the altitude θ of the reflected light is 0 degrees, the reflectance of the reflected light is approximately 80%, and the wave band width of the reflected light is approximately 100 nm around the peak of approximately 650 nm, which is the characteristic of red light. In addition, in the spectrum of the reflected light measured by changing the altitude θ of the reflected light from 0 to 45 degrees, there is a negligible change in the wavelength of the reflected light due to the change of the altitude θ.

FIG. 5B illustrates the result of simulation of a spectrum of green light having a TE wave and reflected from the photonic crystal type color filter of FIG. 4 by changing the altitude 0 of the reflected light. The spatial period “L” of the unit blocks 250, the height “h” of each of the unit blocks 250, and the width “d” of each of the unit blocks 250 were 240 nm, 120 nm, and 120 nm, respectively. Referring to FIG. 5B, when the altitude θ of the reflected light is 0 degrees, the reflectance of the reflected light is approximately 75%, and the wave band width of the reflected light is approximately 100 nm around the peak of approximately 540 nm, which is the characteristic of green light. In addition, in the spectrum of the reflected light measured by changing the altitude θ of the reflected light from 0 to 45 degrees, there is almost no change in the wavelength of the reflected light due to the change of the altitude θ.

FIG. 5C illustrates the result of simulation to obtain a spectrum of blue light having a TE wave and reflected from the photonic crystal type color filter of FIG. 4 by changing the altitude θ of the reflected light. Here, the distance “L” between the unit blocks 250, the height “h” of each of the unit blocks 250, and the width “d” of each of the unit blocks 250 were 210 nm, 90 nm, and 105 nm, respectively. Referring to FIG. 5C, when the altitude θ of the reflected light is 0 degrees, the reflectance of the reflected light is approximately 70%, and the width of the wave band width of the reflected light is approximately 100 nm around the peak of approximately 500 nm, which is the characteristic of blue light. In addition, in the spectrum of the reflected light measured by changing the altitude θ of the reflected light from 0 to 45 degrees, there is almost no change in the wavelength of the reflected light due to the change of the altitude θ.

Advantageously, in the photonic crystal type color filter according to the present embodiment, the reflectance of the reflected light is relatively high (e.g., approximately 70% or greater), and selectivity with respect to the wavelength of the reflected light substantially corresponds to the wave band of the desired color. In addition, even when the altitude of the reflected light is changed, the color of the reflected light is advantageously not changed.

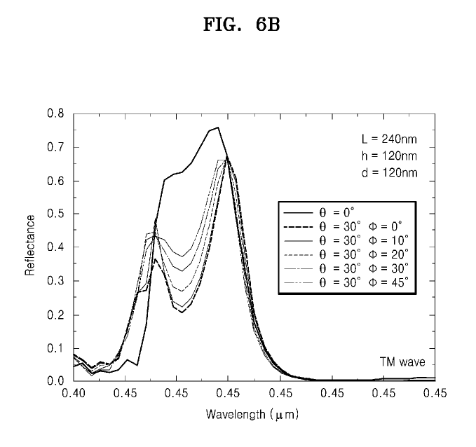

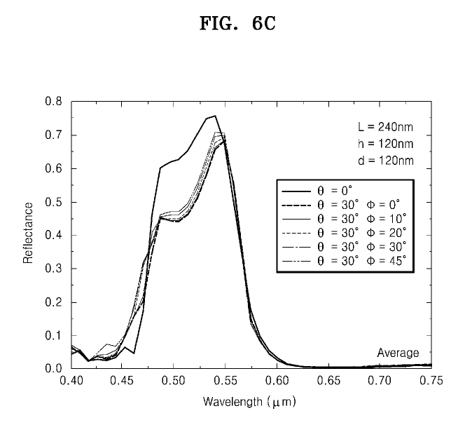

FIGS. 6A through 6C illustrate the spectrum of green light reflected from the photonic crystal type color filter of FIG. 4 according to the azimuth φ of the reflected light. The spatial period “L” of the unit blocks 250, the height “h” of each of the unit blocks 250, and the width “d” of each of the unit blocks 250 were 240 nm, 120 nm, and 120 nm, respectively. Specifically, FIG. 6A illustrates a TE wave spectrum of green light reflected from the photonic crystal type color filter of FIG. 4, and FIG. 6B illustrates a transverse magnetic (“TM”) wave spectrum of green light reflected from the photonic crystal type color filter of FIG. 4. FIG. 6C illustrates the average of the result illustrated in FIGS. 6A and 6B. The results illustrated in FIGS. 6A through 6C are the results measured by changing the azimuth φ of the reflected green light from 0 to 45 degrees in the state where the altitude θ of the reflected light is fixed at 30 degrees in the current simulation.

Referring to FIGS. 6A through 6C, there is a reduction in intensity in the TM wave of reflected green light as compared to the TE wave even when the azimuth φ is changed from 0 to 45 degrees, but there is a negligible change in wavelength.

Advantageously, in the 2D photonic crystal type color filter according to the present embodiment of the present invention, s-polarized light as well as p-polarized light is reflected from the color filter such that luminous efficiency is increased, and the color of the reflected light according to a viewing angle is not changed.

A reflective liquid crystal display (“LCD”) device including the photonic crystal type color filter according to the present invention will now be described.

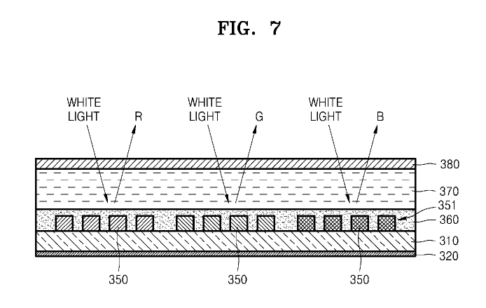

FIG. 7 is a schematic cross-sectional view of an exemplary embodiment of a reflective liquid crystal display (“LCD”) device, according to the present invention. Referring to FIG. 7, the LCD device includes a photonic crystal member 351, a liquid crystal layer 370, and a polarization film 380 are sequentially disposed on a substrate 310. The substrate 310 may be a transparent substrate, such as a glass substrate or a bendable, transparent plastic substrate. A black matrix 320 may be further disposed on the bottom surface of the substrate 310 so as to absorb light transmitted through the substrate 310 to the black matrix 320.

The photonic crystal member 351 may include a two-dimensional grating structure disposed on the substrate 310. The photonic crystal member 351 may include a plurality of unit blocks 350, each having a nano size, which are periodically and two-dimensionally disposed on the substrate 310, and separated from one another at substantially regular intervals. As illustrated in FIG. 7, four unit blocks 350 are disposed in one direction of the photonic crystal member 351, whereas three blocks are disposed in one direction of the photonic crystal layer member 151 of the embodiment in FIGS. 1 and 2.

In the illustrated embodiment, a red pixel, a green pixel, and a blue pixel, in which only predetermined color light (red (R) light, green (G) light or blue (B) light) of incident light is selectively reflected, are disposed on the substrate 310. The pixels may be arranged according to the sizes of each of the unit blocks 350, a distance between adjacent unit blocks 350, a material of the unit blocks 350, and/or a material of the substrate 310 within the pixel, as described in detail in the above-described embodiments. Thus, a description thereof will be omitted.

The unit blocks 350 collectively forming the photonic crystal member 351 may include a material having a refractive index greater than that of the transparent substrate 310. In one exemplary embodiment, the material of the unit blocks 350 may include a crystal, a compound or an organic material having a refractive index greater than about 2.0. The unit blocks 350 may be formed of Si, SiC, ZnS, AlN, BN, GaTe, AgI, TiO₂, SiON, GaP or a compound thereof. However, the present invention is not limited thereto, and each of the unit blocks 350 may have various shapes and be arranged in various formations. The photonic crystal member 351 may be disposed in a multi-layer structure as well as in a single layer structure.

A protection layer 360 may be further disposed on the substrate 310, so as to cover the photonic crystal member 351. The protection layer 360 may directly contact the substrate 310 and surfaces of the unit blocks 350 not facing the substrate 310. The protection layer 360 may include a transparent, organic material, such as polymethylacrylate (PMMA), so as to protect the photonic crystal member 351. However, the present invention is not limited thereto.

The liquid crystal layer 370 is disposed directly on the protection layer 360, which acts as an optical shutter selectively opening or closing to respectively allow through or block incident light from the outside of the photonic crystal member 351. The polarization film 380 is disposed on the liquid crystal layer 370. In an alternative embodiment, a front light unit may be further disposed on and directly adjacent to the polarization film 380. The front light unit may be a light source of the reflective LCD device, such as for use in a dark place.

In the reflective LCD device including the above structure, when white light is incident from an outside of the LCD device, light polarized by the polarization film 380 in a predetermined direction is incident on the photonic crystal member 351 after passing through the liquid crystal layer 370. In one exemplary embodiment, when incident white light reaches a photonic crystal region corresponding to a red pixel, due to the driving of liquid crystals, only red (R) light is reflected from the outside as indicated by the arrows in FIG. 7, and green light (G) and blue light (B) transmit through the substrate 310 and are absorbed by the black matrix 320. When external white light reaches a photonic crystal region corresponding to a green pixel, only green (G) light is reflected from the outside as indicated by the arrows in FIG. 7, and red (R) light and blue (B) light transmit through the substrate 310 and are absorbed by the black matrix 320. When external white light reaches a photonic crystal region corresponding to a blue pixel, only blue (B) light is reflected from the outside as indicated by the arrows in FIG. 7, and red (R) light and green (G) light transmit through the substrate 310 and are absorbed by the black matrix 320.

In the illustrated embodiment of the reflective LCD device according to the present invention, only light of a predetermined color from white light incident from the outside is selectively reflected by the photonic crystal member 351 disposed on the substrate 310, thereby forming and displaying images. The photonic crystal member 351 includes a two-dimensional grating structure, such that luminous efficiency is advantageously increased and selectivity with respect to the wavelength of the reflected light is improved. In addition, even when an incident angle of external light is changed or a viewing angle is changed, the color of the reflected light is advantageously not changed and thus, high color purity can be realized.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A photonic crystal type color filter comprising:
a substrate; and
a photonic crystal disposed on the substrate and having a two-dimensional (2D) grating structure.

2. The photonic crystal type color filter of claim 1, wherein the photonic crystal comprises a plurality of a unit block each having a nano size, the plurality of the unit block being two-dimensionally arranged and collectively defining the grating structure, and the unit blocks being separated from one another at substantially regular intervals.

3. The photonic crystal type color filter of claim 2, wherein a wavelength of light selectively reflected from or transmitted to the photonic crystal type color filter is determined by sizes of the each of the unit blocks, a distance between adjacent ones of the unit blocks, a material of the unit blocks, and a material of the substrate.

4. The photonic crystal type color filter of claim 2, wherein the unit blocks are arranged in substantially a square formation, a hexagonal formation or a combination of square and hexagonal formations.

5. The photonic crystal type color filter of claim 2, wherein the photonic crystal includes a single layer or a multi-layer structure.

6. The photonic crystal type color filter of claim 2, wherein a distance between the adjacent unit blocks is approximately 50 nanometers to approximately 500 nanometers.

7. The photonic crystal type color filter of claim 2, wherein the unit blocks include a crystal, a compound or an organic material having a refractive index greater than about 1.5.

8. The photonic crystal type color filter of claim 2, wherein the unit blocks include Si, SiC, ZnS, AlN, BN, GaTe, AgI, TiO₂, SiON, GaP or a compound thereof.

9. A reflective liquid crystal display (“LCD”) device comprising:
a substrate;
a photonic crystal color filter disposed on the substrate and having a two-dimensional (2D) grating structure;
a liquid crystal layer disposed on the photonic crystal color filter; and
a polarization film disposed on the liquid crystal layer.

10. The reflective LCD device of claim 9, wherein the photonic crystal color filter comprises a plurality of a unit block each having a nano size, the plurality of the unit block being two-dimensionally arranged and collectively defining the grating structure, and the unit blocks being separated from one another at substantially regular intervals.

11. The reflective LCD device of claim 10, wherein a wavelength of light selectively reflected from or transmitted to the photonic crystal color filter, is determined by sizes of each of the unit blocks, a distance between pairs of adjacent ones of the unit blocks, a material of the unit blocks, and a material of the substrate.

12. The reflective LCD device of claim 10, wherein each of the unit blocks includes a crystal, a compound or an organic material having a refractive index greater than about 1.5.

13. The reflective LCD device of claim 12, wherein the unit blocks include Si, SiC, ZnS, AlN, BN, GaTe, AgI, TiO₂, SiON, GaP or a compound thereof.

14. The reflective LCD device of claim 9, further comprising a protection layer disposed on the substrate and directly contacting the photonic crystal color filter.

15. The reflective LCD device of claim 14, wherein the protection layer includes a transparent, organic material.

16. The reflective LCD device of claim 9, wherein the substrate is a transparent substrate.

17. The reflective LCD device of claim 9, further comprising a black matrix absorbing light disposed on a lowermost surface of the substrate, opposing the protection layer with respect to the substrate.

18. The reflective LCD device of claim 9, further comprising a front light unit disposed directly on the polarization film.

19. The reflective LCD device of claim 9, wherein the photonic crystal color filter includes a plurality of the photonic crystal, each photonic crystal including a plurality of a unit block each having a nano size, and each of the photonic crystals selectively reflecting or transmitting a specific wavelength of light to the photonic crystal color filter,
wherein a first photonic crystal includes a first size of each of the unit blocks and a first distance between pairs of adjacent ones of the unit blocks,
wherein a second photonic crystal includes a second size of each of the unit blocks and a second distance between pairs of adjacent ones of the unit blocks,
wherein a third photonic crystal includes a third size of each of the unit blocks and a third distance between pairs of adjacent ones of the unit blocks, and
wherein the first size, the second size and the third size are different from each other, and the first distance, the second distance and the third distance are different from each other.

20. The reflective LCD device of claim 19, wherein the plurality of a unit block within a photonic crystal is arranged substantially linearly in both columns and rows.
